(19) United States
(12) Patent Application Publication
(10) Pub. No.: US 2025/0242354 A1
(43) Pub. Date: Jul. 31, 2025

(54) SYSTEM AND METHOD FOR RETAINING A GRINDER TIP IN A HORIZONTAL GRINDING MACHINE

(71) Applicant: Terex USA, LLC, Norwalk, CT (US)

(72) Inventor: John Pauley, Newton, NH (US)

(21) Appl. No.: 19/037,731

(22) Filed: Jan. 27, 2025

Related U.S. Application Data
(60) Provisional application No. 63/626,118, filed on Jan. 29, 2024.

(51) Int. Cl. B02C 18/18; A01G 23/06

(52) U.S. Cl. CPC B02C 18/18; A01G 23/067

(57) ABSTRACT

A comminuting striker assembly for mounting on a rotor of a comminuting apparatus includes a striker having first and second opposed faces. The first face defines at least one cutting edge, and the second face defines at least one concealed recessed profile. A striker retainer has a leading face for attachment to the striker with at least one concealed protruding profile configured to mate with the concealed recessed profile. A single threaded fastener joins the striker to the striker retainer. When assembled, the interface between the concealed recessed profile and protruding profile is not visible from more than one side of the assembly, preventing direct contact with material being comminuted. Various embodiments include bowtie-shaped, rounded rectangular, and circular array configurations of the concealed profiles that maximize surface contact area and force transmission between the striker and retainer.

### CROSS REFERENCE TO RELATED APPLICATIONS

The present application claims the benefit of the filing date of provisional patent application having Ser. No. 63/626,118 filed on Jan. 29, 2024 by John Pauley entitled CBI PATENT GRINDER TIP ARRANGEMENT, which application is incorporated herein in its entirety by this reference.

### FIELD OF THE INVENTION

The present invention generally relates to methods and equipment for chipping and grinding matter, and more particularly relates to recycling and biomass chippers and grinders, and even more particularly to horizontal grinders and specifically to grinder tips also known as strikers.

### BACKGROUND OF THE INVENTION

Prior art comminuting apparatus for reducing large diameter wood products and stumps to a desired size, have comprised a reduction chamber, with an impact rotor positioned concentrically therein, in combination with a housing, drive motor and infeed conveyor. The impact rotor is formed with a plurality of horizontally elongated impact strikers at its periphery. The rotor is positioned so that the elongated wood product or stump being pulled in via the infeed conveyor the infeed chute is directed against the strikers and repelled ahead of the rotor's rotational direction against an anvil formed along one side of the reduction chamber. Prior art wood comminuting apparatus are often capable of comminuting trees or parts thereof up to 40 inches in diameter (see e.g. U.S. Pat. No. 5,165,611). Strikers used for the comminution are bolted directly to mounting projections on the rotor which is rotated to produce the comminution. These strikers or grinding tip are subjected to significant impacts and the resulting forces often necessitate replacement of the strikers and the threaded fasteners and nuts used to retain them.

Consequently, there exists a need for improved methods and equipment for efficiently replacing these grinder tips.

### SUMMARY OF THE INVENTION

It is an object of the invention to improve maintenance time and ease of striker replacement in comminution apparatus minimizing the potential for loss of components including fasteners.

It is a further object of the invention to eliminate any degradation of structural force transmitting surfaces between the striker and retainer plate by eliminating direct contact with material being comminuted and these mating surfaces between the striker and the retaining plate.

It is another object, for some embodiments of the present invention, to have a mating profile of the striker and the retaining plate match so as to maximize the surface area of contact and/or the force transmission from the striker to the retaining plate.

According to the invention there is provided a comminuting striker assembly for mounting on a rotor of a comminuting apparatus, comprising: a striker having first and second opposed faces, the first face defining at least one cutting edge, and the second face defining at least one concealed recessed profile; a striker retainer having a leading face for attachment to the striker, said leading face defining at least one concealed protruding profile, and an opposed following face; a threaded fastener for joining said striker to said striker retainer, whereby the concealed recessed profile of the striker closely mates with the concealed protruding profile of the striker retainer, so that they are not visible from a point outside of the combined striker and striker retainer plate, when the threaded fastener is disposed. This concealment means that comminuting material, normally wood material and whatever may be coupled to or comingled with the wood, often metals, do not come into direct contact with the interface between the recessed profile and the protruding profile, thereby possibly reducing the difficulty of replacing the striker and/or the retainment plate.

Accordingly, the present invention is a comminuting striker assembly for mounting on a rotor of a comminuting apparatus, comprising:
a striker having first and second opposed faces, the first face defining at least one cutting edge, and the second face defining at least one concealed recessed profile;
a striker retainer having a leading face for attachment to the striker, said leading face defining at least one concealed protruding profile configured to mate with the concealed recessed profile;
a single threaded fastener for joining said striker to said striker retainer; and
wherein when the striker is mounted to the striker retainer, the interface between the concealed recessed profile and the concealed protruding profile is not visible from more than one side of the assembled striker and striker retainer.

### BRIEF DESCRIPTION OF THE DRAWINGS

The invention may be more fully understood by reading the following description of the preferred embodiments of the invention, in conjunction with the appended drawings wherein:

FIG. 1 is a perspective view of striker of the prior art. The dotted circular line in the top of the grinder tip is a void through which a threaded fastener (not shown) can extend.

FIG. 2 is a combined view of striker of FIG. 1 disposed on the prior art retainment plate where a circle is drawn around exposed mated portions of the striker and the retainer plate which are capable of being struck and damaged by material being comminuted.

FIG. 3 is a perspective view of a first side of the striker of the present invention.

FIG. 4 is a reverse side of the striker of FIG. 3.

FIG. 5 is a view of the retainment plate of the present invention.

FIG. 6 is a combined perspective view of the striker of FIG. 3 and mated with the retainment plate of FIG. 5.

FIG. 7 is a bottom view of the striker of FIGS. 3 and 4.

FIG. 8 is a bottom view of an alternate version of striker of the present invention with a rounded rectangular recessed portion.

FIG. 9 is a bottom view of another alternate embodiment of the striker of the present invention with four circular recessed areas around the central hole.

### DETAILED DESCRIPTION

Although described with particular reference to bowtie shaped recessed portion, it should be understood that the innovative and beneficial aspect of the systems and methods of the present invention can be implemented for other configurations as well.

The systems and methods of the present invention described herein can be viewed as examples of many potential variations of the present invention which are protected hereunder. The following details are intended to aid in the understanding of the invention whose scope is defined in the claims appended hereto. The following description should be viewed as an example of other embodiments of the present invention, which may employ systems and methods which deviate from the details described below, without departing from the spirit and the intended scope of the invention.

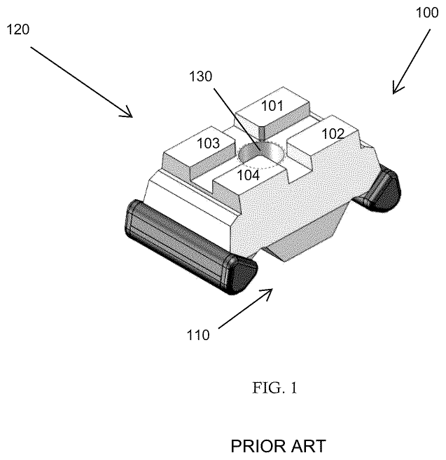

Now referring to the drawings wherein like numerals refer to like matter throughout, and more particularly in FIG. 1, there is shown a prior art grinder tip with a cross shaped void there for receiving a cross shaped protruding portion of a retaining plate of the prior art.

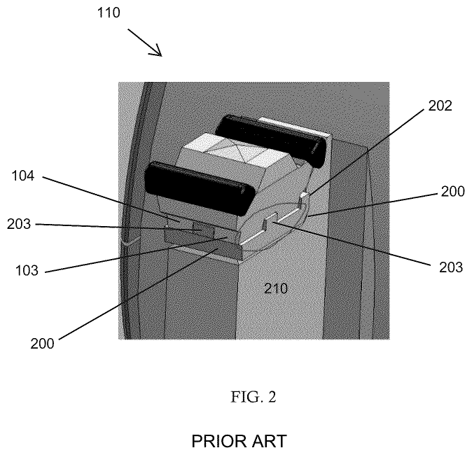

Now referring to FIG. 2, which shows a prior art combination of grinder tip 100 with a retainment plate 200 having a cross shape protruding portion 203 thereon which fits into the cross shaped void grinder tip 100 which is bounded by portions 101, 102, 103, and 104 of grinder tip 100. The interface between the protruding portions of retention plate 200 and the portion 104 and 103 of grinder tip 100 are visible and therefore open to direct contact with comminuting material.

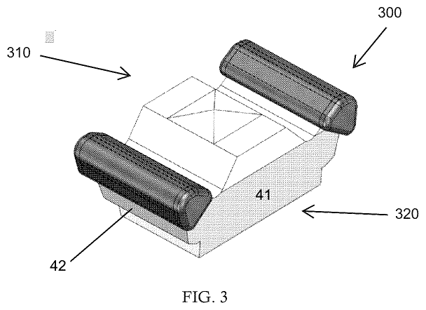

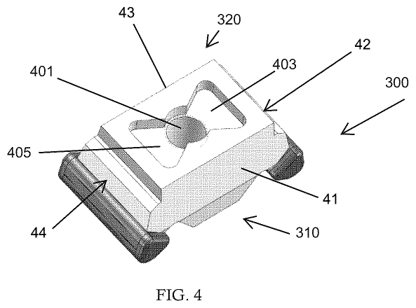

Now referring to FIGS. 3 and 4, there is shown a grinder tip 300 of the present invention which includes a top side 310; bottom side 320, first side 41; second side 42; third side 43 and fourth side 44. In FIG. 4, the bowtie shaped recess is shown with first recessed portion 403 and second recess portion 405 with a central hole 401 therebetween for receiving a threaded fastener.

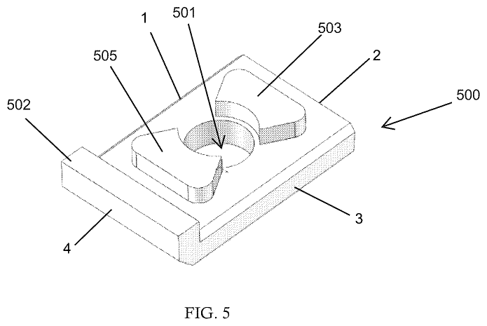

Now referring to FIG. 5, there is shown a retainer plate 500 of the present invention, have a first retainer side 1, second retainer side 2, third retainer side 3; fourth retainer side 4; and a central hole 501 for receiving the same threaded fastener as 401. Also shown are protruding portions 503 and 505 which are configured to fit inside the first recessed portion 403 and second recess portion 405, respectively.

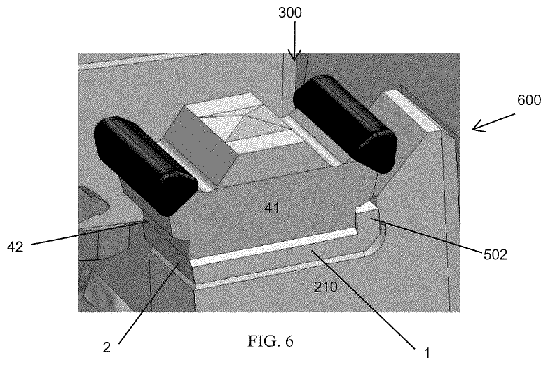

Now referring to FIG. 6, there is shown an assembled portion of the present invention with retainer plate 500 and grinder tip 300 disposed on an upright protruding from the rotor, not shown. Note that no portions of protruding portions 503 and 505 are visible.

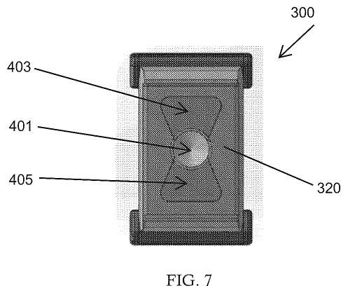

Now referring to FIG. 7, there is shown a bottom view of the grinder tip 300 of the present invention.

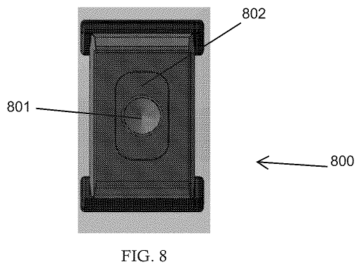

Now referring to FIG. 8, there is shown an alternate embodiment of the present invention with a rounded rectangular recessed portion 802 and a central threaded fastener hole 801.

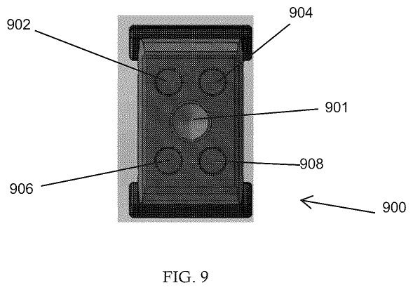

Now referring to FIG. 9, there is shown yet another alternate embodiment of the present invention where a rectangular array of recessed areas 902, 904, 906 and 908 are shown.

The precise implementation of the present invention will vary depending upon the particular application.

It is thought that the method and apparatus of the present invention will be understood from the foregoing description and that it will be apparent that various changes may be made in the form, construct steps and arrangement of the parts and steps thereof without departing from the spirit and scope of the invention or sacrificing all of their material advantages. The form herein described is merely a preferred and/or exemplary embodiment thereof.

1. A comminuting striker assembly for mounting on a rotor of a comminuting apparatus, comprising:
a striker having first and second opposed faces, the first face defining at least one cutting edge, and the second face defining at least one concealed recessed profile;
a striker retainer having a leading face for attachment to the striker, said leading face defining at least one concealed protruding profile configured to mate with the concealed recessed profile;
a single threaded fastener for joining said striker to said striker retainer; and
wherein when the striker is mounted to the striker retainer, the interface between the concealed recessed profile and the concealed protruding profile is not visible from more than one side of the assembled striker and striker retainer.

2. The comminuting striker assembly of claim 1, wherein the concealed recessed profile comprises a bowtie-shaped recess having first and second recessed portions with a central hole therebetween for receiving the threaded fastener.

3. The comminuting striker assembly of claim 2, wherein the concealed recessed profile comprises a rounded rectangular recess with a central hole for receiving the threaded fastener.

4. The comminuting striker assembly of claim 2, wherein the mating profile of the striker and the retaining plate match so as to maximize the surface area of contact and force transmission from the striker to the retaining plate.

5. A comminuting striker assembly for mounting on a rotor of a comminuting apparatus, comprising:
a striker having first and second opposed faces, the first face defining at least one cutting edge, and the second face defining at least one concealed recessed profile;
a striker retainer having a leading face for attachment to the striker, said leading face defining at least one concealed protruding profile configured to mate with the concealed recessed profile;
a single threaded fastener for joining said striker to said striker retainer;
wherein when the striker is mounted to the striker retainer, the interface between the concealed recessed profile and the concealed protruding profile is not visible from more than one side of the assembled striker and striker retainer; and
wherein the mating profile of the striker and the retaining plate match so as to maximize the surface area of contact and force transmission from the striker to the retaining plate.

6. The comminuting striker assembly of claim 5, wherein the concealed recessed profile comprises a bowtie-shaped recess having first and second recessed portions with a central hole therebetween for receiving the threaded fastener.

7. The comminuting striker assembly of claim 3, wherein the concealed recessed profile comprises four circular recessed areas arranged in a rectangular array around the central hole for receiving the threaded fastener.

8. A method of replacing a striker in a comminuting apparatus, comprising:
providing a striker having a concealed recessed profile on a mounting face;
providing a striker retainer having a concealed protruding profile configured to mate with the concealed recessed profile;
aligning the concealed recessed profile with the concealed protruding profile;
securing the striker to the striker retainer with a single threaded fastener; and
wherein the interface between the recessed profile and protruding profile is concealed from contact with material being comminuted when assembled.

9. The method of claim 8, wherein the concealed recessed profile and concealed protruding profile have matching bowtie-shaped configurations.

10. The method of claim 8, wherein the concealed recessed profile and concealed protruding profile have matching rounded rectangular configurations.

11. The method of claim 8, wherein the concealed recessed profile comprises multiple circular recessed areas arranged around a central fastener hole.

12-13. (canceled)
